(19) United States
(12) Patent Application Publication
(10) Pub. No.: US 2025/0289349 A1
(43) Pub. Date: Sep. 18, 2025

(54) VEHICLE SEAT WITH ROLLER GUIDE

(71) Applicant: GRAMMER Aktiengesellschaft, Ursensollen (DE)

(72) Inventors: Florian SCHANDERL, Schwarzenfeld (DE); Sebastian SCHMAUSSER, Ursensollen (DE); Thomas PFEIL, Amberg (DE)

(73) Assignee: GRAMMER Aktiengesellschaft, Ursensollen (DE)

(21) Appl. No.: 19/074,985

(22) Filed: Mar. 10, 2025

(30) Foreign Application Priority Data
Mar. 15, 2024 (DE) 10 2024 107 524.4

(51) Int. Cl. B60N 2/16

(52) U.S. Cl. CPC B60N 2/162; B60N 2/1625

(57) ABSTRACT

A vehicle seat having a seat part and a vehicle seat base with a frame part for supporting the seat part or for attachment to a vehicle body and a height-adjustable scissors mechanism with a scissors arm. The frame part has a first rail element. An end of the first scissors arm is connected to the first rail element by a floating bearing that has a rolling element with an axle and a sliding element that are arranged one behind the other The rolling element has a contact point with a rolling plane of the first rail element and the sliding element has a contact point with a sliding plane of the first rail element or of a second rail element of the frame part. The rolling plane and the sliding plane are aligned at an angle α from a range 0<α<90° to one another.

### CROSS REFERENCE TO RELATED APPLICATION

This application claims the benefit of German Patent Application No. 10 2024 107 524.4, filed Mar. 15, 2024, the entire contents of which are hereby incorporated herein by reference.

### FIELD

The present invention relates to a vehicle seat comprising a seat part and a vehicle seat base with a frame part for supporting the seat part or for attachment to a vehicle body and a height-adjustable scissors mechanism, wherein the scissors mechanism has at least one first scissors arm and the frame part has at least one first rail element, wherein at least one end of the first scissors arm is connected to the first rail element by means of a floating bearing, wherein the floating bearing has a rolling element with an axle and a sliding element and the rolling element and the sliding element are arranged one behind the other in the rolling axis direction, the rolling element rotates about a rolling axis of the axle, wherein the rolling element has at least one contact point with a rolling plane of the first rail element and the sliding element has at least one contact point with a sliding plane of the first rail element or of a second rail element of the frame part, wherein the rolling plane and the sliding plane are aligned at an angle α from a range 0<α<90⁰ to one another.

### BACKGROUND

In motor vehicles, especially in commercial vehicles such as tractors or trucks, the vehicle seats are designed for maximum comfort due to their intensive use. In contrast to seats for passenger cars, such vehicle seats have a suspension in the vehicle seat base in addition to the vehicle suspension. A spring movement or general height adjustability is made possible by a scissors mechanism that supports a seat part. To connect the seat part and scissors mechanism, a frame is arranged between the two, in which the scissors mechanism can perform a scissors movement, i.e. two scissors arms can move apart or towards each other. To do this, at least one scissors arm must be connected to the frame via a floating bearing. Such a floating bearing is usually formed by a roller that is guided in a guide rail of the frame. When the parts are manufactured or assembled, component and assembly tolerances must always be taken into account, which on the one hand impairs the guidance of the roller and thus the mobility of the scissors mechanism due to excessive play and on the other hand increases wear due to the play.

### SUMMARY

It is therefore the task of the invention to provide a vehicle seat which remedies the disadvantages of the prior art and eliminates the play of a floating bearing by means of a combination of roller and slider.

The problem is solved according to the invention by the objects of the independent claims. Advantageous embodiments and further embodiments of the invention are the subject of the subclaims.

This problem is solved by a vehicle seat comprising a seat part and a vehicle seat base with a frame part for supporting the seat part or for attachment to a vehicle body and a height-adjustable scissors mechanism, wherein the scissors mechanism has at least one first scissors arm and the frame part has at least one first rail element, wherein at least one end of the first scissors arm is connected to the first rail element by means of a floating bearing. The floating bearing has a rolling element with an axle and a sliding element, and the rolling element and the sliding element are arranged one behind the other in the rolling axis direction, wherein the rolling element rotates about a rolling axis of the axle. The rolling element has at least one point of contact with a rolling plane of the first rail element and the sliding element has at least one point of contact with a sliding plane of the first rail element or a second rail element of the frame part, wherein the rolling plane and the sliding plane are aligned at an angle α from a range 0<α<90° to each other.

The rolling plane is spanned by the surface formed by all the contact points provided between the rolling element and the rail element. So, when the roller element is moved along the rail element, the piece along which the roller runs forms the surface that spans the roller plane. Preferably, the rolling plane is flat, i.e. not curved. The same applies to the sliding plane. The sliding plane is spanned by the surface formed by all the contact points provided between the sliding element and the rail element. Preferably, the sliding plane is also flat, i.e. not curved. Preferably, the rail element has a flat section along which the sliding element and the rolling element move. Preferably, the rolling plane and the sliding plane run parallel in one direction, for example both extend parallel to the longitudinal direction X or width direction Y. According to the invention, the two planes are not parallel, but include an angle α>0. Furthermore, the planes are not perpendicular to each other, so the included angle α<90°. The angle α also corresponds to the acute angle between the normals of the rolling plane and the sliding plane.

According to a particularly preferred embodiment, the first rail element and/or the second rail element extend along a longitudinal direction X or width direction Y of the vehicle seat, wherein the first and/or the second rail element are each designed to guide the rolling element and/or the sliding element, wherein the rolling plane forms a first surface of the first rail element and the sliding plane forms a second surface of the first or the second rail element.

According to a particularly preferred embodiment, the rolling plane and the sliding plane extend along the longitudinal direction X and/or width direction Y of the vehicle seat.

Preferably, the rolling plane is aligned perpendicular to the height direction Z of the vehicle seat so that the forces can be optimally transmitted by the seat and/or a user to the scissors mechanism and thus also to the body. Preferably, the roller and sliding plane are aligned with the main extension of the first and/or second rail element, i.e. they run parallel to it.

According to a particularly preferred embodiment, the angle is from a range of 45°<α<60°.

Depending on the angle of the sliding surface to the rolling axis, a force exerted by the sliding plane on the sliding element acts more along the rolling axis or more perpendicular to the rolling axis. Preferably, the axle with its rolling axis and the rolling plane run parallel to the width direction Y of the vehicle seat and the sliding plane and the rolling plane run parallel to the longitudinal direction X of the vehicle seat. If the sliding planes and the rolling plane are aligned at an angle α to each other, the sliding plane and the rolling axis are also aligned at this angle α to each other. If the angle α is less than 45°, this means that the sliding plane is aligned with the width direction Y rather than the height direction Z. A force exerted by the sliding plane on the sliding element then acts more in the height direction Z than in the width direction Y. If the angle α is greater than 45°, this means that the sliding plane is aligned more in the height direction Z than in the width direction Y. A force exerted by the sliding plane on the sliding element then acts more in the width direction Y than in the height direction Z. Preferably it holds α>45°. Preferably, the sliding element is pressed against the axle by the sliding plane.

According to a particularly preferred embodiment, the rolling element and the sliding element are mounted on the end face of the axle, wherein the rolling element has a first cylindrical recess and the sliding element has a second cylindrical recess and the axle is inserted through the recess of the rolling element and through or into the recess of the sliding element, wherein the sliding element forms a half positive fit for the rolling element.

According to a particularly preferred embodiment, the axle has a first diameter where the sliding element is mounted, wherein the diameter of the second cylindrical recess is smaller than the first diameter, so that a fit between the axle and the sliding element is an interference fit.

Preferably, the roller element is a roller, and the sliding element is a slider. The axle is preferably cylindrical in shape and has a receiving area at one end in which the rolling element and the sliding element are mounted. Preferably, the axle forms a stop towards its centre, which forms a half positive fit for the rolling element. This prevents the rolling element from slipping towards the centre of the axle. The rolling element is preferably pushed onto the axle. The fit between the rolling element and the axle is preferably a clearance fit or a transition fit and allows the rolling element a certain amount of movement, i.e. play along the rolling axis. To prevent the rolling element from slipping off the axle, the sliding element preferably forms a second stop for the rolling element. The sliding element can be pressed onto the axle for fastening. For this purpose, the sliding element can have a cylindrical recess that is smaller than the diameter of the axle at its front end, whereby, when the axle is inserted into the recess of the sliding element, a frictional connection is formed between the sliding element and the axle. As a result, no additional fastening means such as screws, clamps, adhesives or the like are required to fasten the roller element and/or the sliding element to the axle.

According to a particularly preferred embodiment, the sliding element is rotationally symmetrical, with an axis of rotation of the sliding element and an axis of rotation of the second cylindrical recess corresponding to the rolling axis.

Preferably, the interference fit allows the sliding element to rotate about the rolling axis. A rotationally symmetrical sliding element can now perform a rotation around the rolling axis and at the same time maintain contact with the sliding plane. This means that the contact point between the sliding element and the sliding plane can change, which prevents the sliding element from wearing on one side. Preferably, the sliding element is at least partially conical in shape. Preferably, the angle between the radius of the base area of the cone and an adjoining generatrix of the cone corresponds to α. According to a preferred embodiment, the shell and the generatrix of the cone are convexly curved.

According to a particularly preferred embodiment, the contact point of the sliding element is below the rolling axis and the contact point of the rolling element is above the rolling axis when viewed in the height direction of the vehicle seat, or the contact point of the rolling element is below the rolling axis and the contact point of the sliding element is above the rolling axis.

Since the sliding plane is not perpendicular to the rolling plane, the sliding plane always exerts a force on the sliding element and thus on the axle in the height direction Z. If the contact points of the sliding element and the rolling element are on different sides of the rolling axis, any play of the axle along the height direction Z can be limited in one direction by the contact between the rolling element and the rolling plane and in the other direction by the contact between the sliding element and the sliding plane. Preferably, the height play of the axle relative to the first rail element is eliminated by the contact points with the sliding plane and with the rolling plane.

According to a particularly preferred embodiment, the first rail element has a central web, an upper web and a lower web, wherein the central web is arranged between the upper web and the lower web and the rail element is U-shaped in a section perpendicular to its main axis of extension.

According to a particularly preferred embodiment, the rolling element and the sliding element are at least partially enclosed by the U-shaped first rail element. The rolling plane is formed by the first surface of the upper web or the lower web and the sliding plane is formed by the second surface of the central web.

Due to the U-shape, the rail element can preferably accommodate the roller element and the sliding element completely. Preferably, the rail element has a boundary directed towards the axle. This prevents the rolling element and the sliding element from slipping out of the U-shaped rail element. Preferably, the first surface is part of the rolling plane, and the second surface is part of the sliding plane.

According to a particularly preferred embodiment, the vehicle seat base comprises a third rail element which is arranged parallel to the first rail element and/or a fourth rail element which is arranged in its main axis of extension parallel to the main axis of extension of the second rail element. The first scissors arm is connected to the third rail element by means of a second floating bearing, wherein the second floating bearing has a second rolling element with the axle and a second sliding element and the second rolling element and the second sliding element are arranged one behind the other in the rolling axis direction, wherein the second rolling element has at least one contact point with a second rolling plane of the third rail element and the second sliding element has at least one contact point with a second sliding plane of the third rail element or of the fourth rail element. The second rolling plane and the second sliding plane are aligned at a second angle β from a range 0<β<90° to each other.

In order to be able to eliminate play along the rolling axis in addition to eliminating play in the height direction Z, the axle can have a second receiving area with a second rolling element and a second sliding element at a second end. Preferably, the second rolling plane is parallel to the rolling plane, with the second sliding plane being aligned at an angle β to the second rolling plane. A force can act from a second sliding plane on the second sliding element and thus on the axle along the rolling axis, in the opposite direction to the force of the sliding plane on the sliding element along the rolling axis. The sliding planes can thus limit the movement of the axle along the rolling direction.

According to a particularly preferred embodiment, the rolling plane is equal to the second rolling plane and the angle α is equal to the second angle β.

The invention also provides a vehicle seat comprising a seat part and a vehicle seat base with an adjustment device for displacing the vehicle seat relative to a vehicle body in at least one of the longitudinal direction X, the width direction Y or the height direction Z and a frame part for supporting the seat part or for fastening it to the vehicle body. The frame part has at least one first rail element, wherein the adjustment device is connected to the first rail element by means of at least one floating bearing, wherein the floating bearing has a rolling element with a rolling axis and a sliding element, and the rolling element and the sliding element are arranged one behind the other in the rolling axis direction. The rolling element has at least one point of contact with a rolling plane of the first rail element and the sliding element has at least one point of contact with a sliding plane of the first rail element or a second rail element of the frame part, wherein the rolling plane and the sliding plane are aligned at an angle α from a range 0<α<90° to each other.

Further objectives, advantages and usefulness of the present invention can be found in the following description in conjunction with the drawing.

### BRIEF DESCRIPTION OF THE DRAWINGS

FIG. 1 a vehicle seat according to the invention;

FIG. 2 a vehicle seat base according to the invention;

FIG. 3 a floating bearing of an upper frame part;

FIG. 4 a frontal view of an upper frame part;

FIG. 5a an isometric view of a slider and

FIG. 5b a sectional view of a slider.

### DETAILED DESCRIPTION

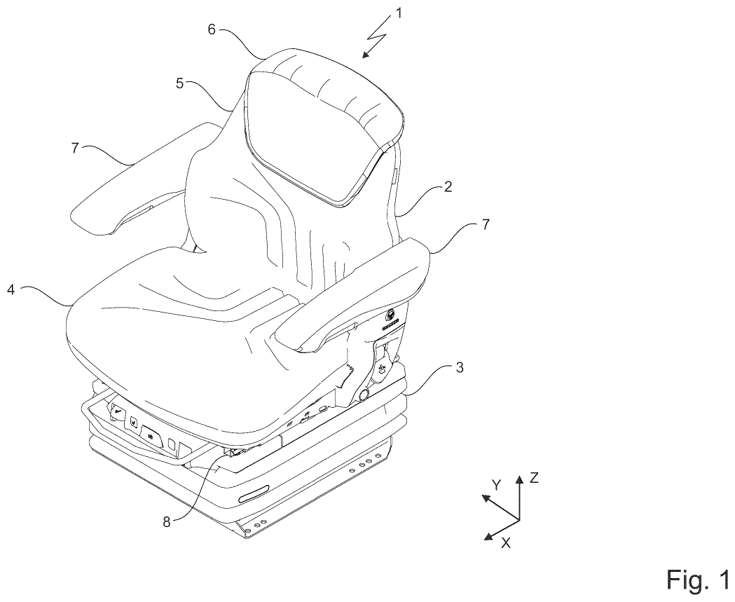

FIG. 1 shows a vehicle seat 1 according to the invention. The vehicle seat 1 extends in a longitudinal direction X, a width direction Y, and a height direction Z. The seat part 2 is arranged in an upper part. The seat part 2 comprises a seat cushion 4, a backrest 5, a headrest 6 and two armrests 7. As is usual with vehicle seats, the seat cushion 4, backrest 5 and the armrests 7 can be tilted about the width direction Y. The vehicle seat base 3, which supports the seat part 2, is arranged in a lower part. The seat part 2 can be displaced in the longitudinal direction X relative to the vehicle seat base 3 by means of an adjustment device 8. The lower end of the vehicle seat substructure 3 is bolted to the body of a vehicle.

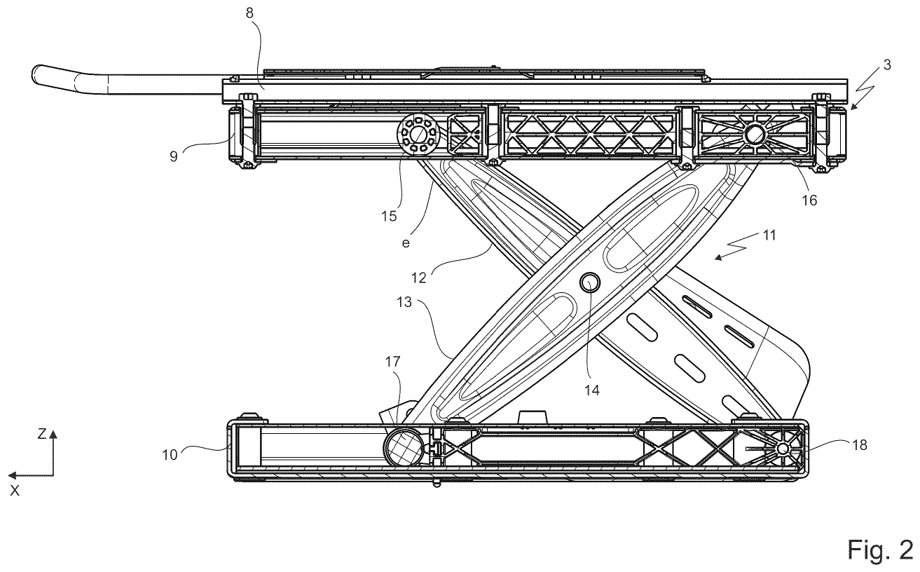

FIG. 2 shows a vehicle seat base 3 according to the invention. The vehicle seat base 3 has an upper frame part 9, which carries the adjustment device 8 and thus the seat part, and a lower frame part 10 for fastening the vehicle seat base 3 to the body of the vehicle. The two frame parts 9, 10 are rectangular and extend mainly in the longitudinal direction X. A scissors mechanism 11 with a first scissors arm 12 and a second scissors arm 13 is arranged between the upper and lower frame parts 9, 10. The first scissors arm 12 and the second scissors arm 13 are rotatably connected to each other about a scissors mechanism pivot 14. The upper frame part 9 is connected to an upper end e of the first scissors arm 12 via a first floating bearing 15 and to an upper end of the second scissors arm 13 via a first fixed bearing 16. The first floating bearing 15 and the first fixed bearing 16 are arranged at the same height in height direction Z, with the floating bearing 15 being located in front of the fixed bearing 16 in longitudinal direction X. Forces acting on the upper frame part 9 are transmitted to the scissors mechanism 11 via the two first bearings 15, 16. Similarly, the lower frame part 10 is connected to a lower end of the second scissors arm 13 via a second floating bearing 17 and is connected to a lower end of the first scissors arm 12 via a second fixed bearing 18. The second floating bearing 17 and the second fixed bearing 18 are arranged at the same height in height direction Z, with the floating bearing 17 being located in front of the fixed bearing 18 in longitudinal direction X. Forces are transmitted from the scissors mechanism 11 to the lower frame part 10 and thus to the body via the two second bearings 17, 18. An air spring, not shown here, is connected on the one hand to the first scissors arm 12 and on the other hand to the lower frame 10. A force with which the two scissors arms are pressed apart is predetermined by a spring rate of the air spring. Since the two scissors arms 12, 13 are connected to each other via the scissors mechanism pivot 14, the distance between the two fixed bearings 16, 18 or between the two floating bearings 15, 17 increases when the distance between the first floating bearing 15 and the first fixed bearing 16 is reduced or the distance between the second floating bearing 17 and the second fixed bearing 18 is reduced. This allows the distance between the upper frame part 9 and the lower frame part 10 to be changed. In order to be able to accommodate a change in the distance between the first bearings 15, 16 and the second bearings 17, 18, the floating bearings 15, 17 can move relative to the frame parts 9, 10 in the longitudinal direction X. The frame parts 9, 10 are designed to guide the floating bearings 15, 17.

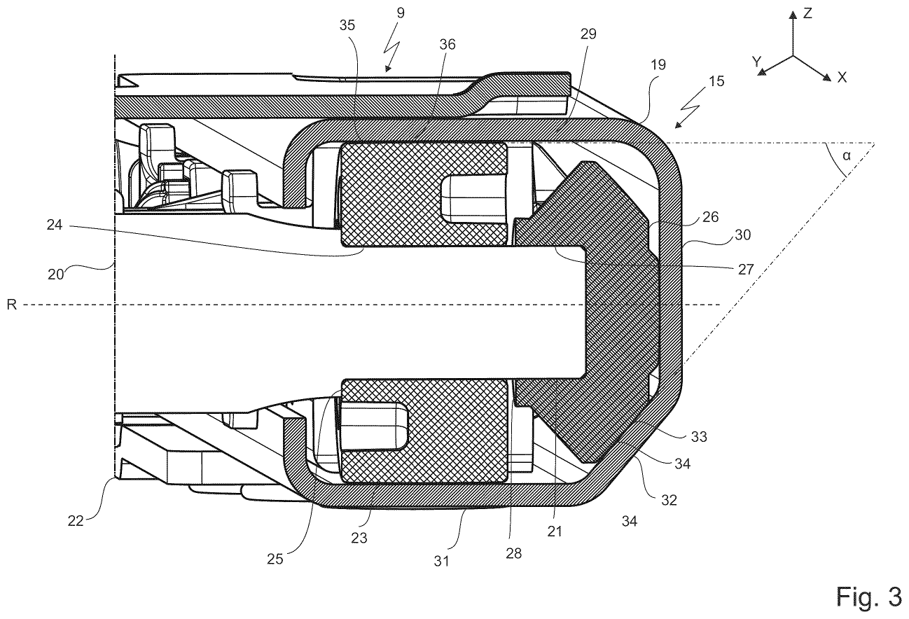

FIG. 3 shows the first floating bearing 15 of the upper frame part 9. The frame part has a first guide rail 19, which accommodates an axle 20 with a roller 23 as a rolling element and a slider 26 as a sliding element. The axle 20 forms part of the upper end of the first scissors arm 12 and runs parallel to the width direction Y. The axle 20 has a cylindrical outer area 21 and an inner area 22. The roller 23 is slid onto the outer area 21. For this purpose, the roller 23 has an inner diameter 24 which is larger than the diameter of the outer area 21. In order to limit the roller 23 in a displacement in the direction of the inner area 22, parallel to the width direction Y, the axle 20 has a first stop 25 for the roller 23 at the transition from the inner 22 to the outer area 21. Opposite the stop 25, a slider 26 is attached to the axle 20. The slider 26 has an inner diameter 27 which is smaller than the diameter of the axle 20 in the outer area 21. The slider 26 is pressed onto the axle 20 and forms a second stop 28 for the roller. The distance between the first stop 25 and the second stop 28 is greater than the width of the roller 23, so that it has a clearance in the width direction Y. The outer area 21 of the axle 20 is almost completely enclosed by the U-shaped first guide rail 19. The first guide rail has an upper web 29 which runs parallel to the width direction Y above the axle 20. The upper web then merges into a central web 30, which closes off the outer area 21 along the height direction Z. Finally, the middle web 30 merges into a lower web 31, which runs parallel to the upper web 29. All webs 29, 30, 31 also extend along the longitudinal direction X. The central web 30 forms a lower section 32, which is set at an angle α of 50° relative to the width direction Y. The inner side, i.e. the side of the lower section 32 facing the axle 20, forms a sliding surface 33 for the slider 26, the slider 26 touching the sliding surface 33 at a contact point 34. Similarly, the inner side of the upper web 29 forms a rolling surface 35 for the roller 23, the roller 23 contacting the rolling surface 35 at a contact point 36. The contact point 34 of the slider 26 is located below the axle 20 or below the rolling axis, whereas the contact point 36 of the roller 23 is located above the axle 20 or above the rolling axis.

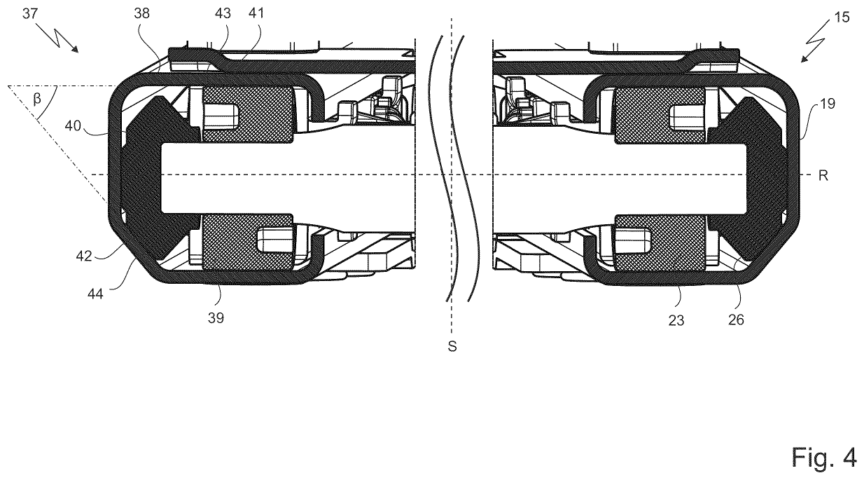

FIG. 4 shows the upper frame part 9. The first scissors arm 12 is connected to a second guide rail 38 via a third floating bearing 37. The third floating bearing 37 and the second guide rail are constructed analogously to the first floating bearing 15 and the first guide rail, thus corresponding to a mirroring of the first floating bearing 15 or the first guide rail 19 on the mirror plane S, which extends parallel to the X-Z direction. Accordingly, the axle 20 has at its left end a second roller 39 with a contact point 41 with a second rolling surface 43 and a second slider 40 with a contact point 42 with a second sliding surface 44. The contact points 41, 42 correspond to the points of contact between the second guide rail 38 and the second roller 39 or the second slider 40. The two guide rails 19, 38 are spaced apart by cross connections not shown here. The distance between the two guide rails 19, 38 is adjustable. If the distance between the two guide rails 19, 38 is increased evenly along the rolling axis R, the centre bar 30 or the guide rail 19 is removed from the slider 26, causing the slider 26 to lose its contact point 34. The same applies to the second slider 40, which loses its contact point 42 when the second guide rail 38 is removed from the second slider 40. The distance between the sliders 26, 40 is unchangeable, as the sliders 26, 40 are firmly pressed onto the axle 20. By reducing the distance between the guide rails 19, 38, the sliders 26, 40 come into contact with the guide rails 19, 38 again. Since the sliding surfaces 33, 44 are positioned at an angle α equal to 50° or β equal to 50° relative to the rolling surfaces 35, 43 and are therefore also positioned at 50° relative to the rolling axis R, since the rolling surfaces 35, 43 run parallel to the rolling axis R, a reduction in the distance between the guide rails 19, 38 causes the contact points 34, 42 of the sliders 26, 40 to move upwards along the sliding surfaces 33, 44 in the height direction Z. As a result, the axle 20 is displaced upwards relative to the guide rails 19, 38, causing the rollers 23, 39 to move against the rolling surfaces 35, 43. are pressed. The guide rail thus forms a positive fit for the axle 20 with rollers 23, 39 and sliders 26, 40 in width direction Y and height direction Z. This eliminates any play of the floating bearings 15, 37 in width direction Y and height direction Z.

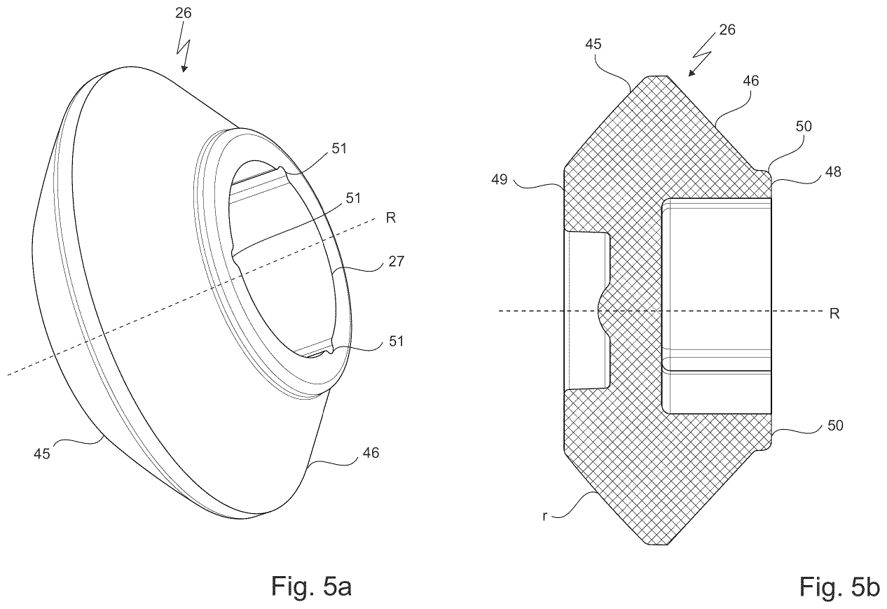

FIGS. 5a and 5b show a slider. The slider 26 is shaped as a double frustum of a cone. The frustum is rotationally symmetrical to the rolling axis R. An outer frustum 45 is placed with its base area 47 on the base area 47 of an inner frustum 46, whereby the radii of the two base areas are equal. The radius of the base surface corresponds to the height of the slider 26 and the sum of the heights of the two frustums of a cone 45, 46 corresponds to the width of the slider 26. Outer and inner also refer to the arrangement of the slider on the axle 20, so the inner frustum 46 is directed towards the roller 23 and the outer frustum is directed away from the roller 23. The inner frustum 46 has a cylindrical recess with an inner diameter 27 that is smaller than the diameter of the outer area 21 of the axle 20. The cylindrical recess is also arranged rotationally symmetrically about the rolling axis R. The height of the inner frustum 46 is greater than the height of the outer frustum 45 and the height of the cylindrical recess is greater than half the width of the slider 26. This ensures that a greater proportion of the volume of the slider 26 sits on the axle 20 than next to it. Around the edge of the cylindrical recess, the inner frustum has a reinforcement 50 on the inner top area 48 in order to protect the inner frustum 46 against break-out of the material when the slider 26 is pressed onto the axle 20. In addition, three channels 51 are arranged evenly radially around the rolling axis R on the shell of the cylindrical shaping. The channels 51 have a semicircular base area and extend over the entire height of the cylindrical recess. Air that would otherwise be trapped in the cylindrical recess can escape through these channels 51 when the slider 26 is pressed onto the axle. The lateral surface of the outer frustum 45 is set at the same angle α of 50° to the base area as the sliding surface is set to the rolling surface. In addition, the lateral surface of the outer frustum is curved concavely with a radius r of 60 mm towards the centre of the slider 26. On the one hand, the curvature makes it possible to compensate for manufacturing tolerances with regard to the angle α and, on the other hand, to ensure that the slider 26 forms only one contact point 34 instead of a contact surface, which can reduce the friction between the slider 26 and the guide rail 19.

The applicant reserves the right to claim all the features disclosed in the application documents as being essential to the invention, provided that they are new, either individually or in combination, compared with the prior art. It should also be that the individual figures also describe features which may be advantageous in. The person skilled in the art will immediately recognize that a certain feature described in a figure can also advantageous without the adoption of further features from this figure. Furthermore, the skilled person recognizes that advantages can also result from a combination of several features shown in individual figures or in different figures.

### LIST OF REFERENCE SYMBOLS

1 Vehicle seat
2 Seat part
3 Vehicle seat base
4 Seat cushion
5 Backrest
6 Headrest
7 Armrest
8 Adjustment device
9 Upper frame part
10 Lower frame part
11 Scissors mechanism
12 First scissors arm
13 Second scissors arm
14 Scissors mechanism pivot
15 First floating bearing
16 First fixed bearing
17 Second floating bearing
18 Second fixed bearing
19 First guide rail
20 Axle
21 Outer area
22 Inner area
23 Roller
24 Inner diameter of the roller
25 First stop of the roller
26 Slider
27 Inner diameter of the slider
28 Second stop of the roller
29 Upper web
30 Centre bar
31 Lower web
32 Lower section
33 Sliding surface
34 Contact point of the slider
35 Rolling surface
36 Contact point of the roller
37 Third floating bearing
38 Second guide rail
39 Second roller
40 Second slider
41 Contact point of the second roller
42 Contact point of the second slider
43 Second rolling surface
44 Second sliding surface
45 Outer frustum of a cone
46 Inner frustum of a cone
47 Base area
48 Inner top area
49 Outer top area
50 Reinforcement
51 Channels
X Longitudinal direction
Y Width direction
Z Height direction
R Rolling axis
S Mirror plane
α Angle α
β Angle β
r Radius
e End of the first scissors arm

What is claimed is:

1. A vehicle seat comprising a seat part and a vehicle seat base with a frame part for supporting the seat part or for attachment to a vehicle body and a height-adjustable scissors mechanism, wherein the scissors mechanism has at least one first scissors arm and the frame part has at least one first rail element, wherein at least one end of the first scissors arm is connected to the first rail element by means of a floating bearing, wherein the floating bearing has a rolling element with an axle and a sliding element and the rolling element and the sliding element are arranged one behind the other in the rolling axis direction, the rolling element rotates about a rolling axis of the axle, wherein the rolling element has at least one contact point with a rolling plane of the first rail element and the sliding element has at least one contact point with a sliding plane of the first rail element or of a second rail element of the frame part, wherein
the rolling plane and the sliding plane are aligned at an angle α from a range 0<α<90° to each other.

2. The vehicle seat according to claim 1, wherein
the first rail element and/or the second rail element extend along a longitudinal direction (X) or width direction (Y) of the vehicle seat, wherein the first and/or the second rail element are each designed to guide the rolling element and/or the sliding element, wherein the rolling plane forms a first surface of the first rail element and the sliding plane forms a second surface of the first or the second rail element.

3. The vehicle seat according to claim 1, wherein
the rolling plane and the sliding plane extend along the longitudinal direction (X) and/or width direction (Y) of the vehicle seat.

4. The vehicle seat according to claim 1, wherein
the angle α from is a range of 45°<α<60°.

5. The vehicle seat according to claim 1, wherein
the rolling element and the sliding element are mounted on the end face of the axle, the rolling element having a first cylindrical recess and the sliding element having a second cylindrical recess and the axle being inserted through the recess of the rolling element and through or into the recess of the sliding element, the sliding element forming a half positive fit for the rolling element.

6. The vehicle seat according to claim 5, wherein
the axle has a first diameter where the sliding element is mounted, the diameter of the second cylindrical recess being smaller than the first diameter, so that a fit between the axle and the sliding element is an interference fit.

7. The vehicle seat according to claim 5, wherein
the sliding element is rotationally symmetrical, wherein an axis of rotation of the sliding element and an axis of rotation of the second cylindrical recess correspond to the rolling axis.

8. The vehicle seat according to claim 1, wherein
the contact point of the sliding element lies below the rolling axis and the contact point of the rolling element lies above the rolling axis when viewed in the height direction of the vehicle seat, or the contact point of the rolling element lies below the rolling axis and the contact point of the sliding element lies above the rolling axis.

9. The vehicle seat according to claim 1, wherein
the first rail element has a central web, an upper web and a lower web, wherein the central web is arranged between the upper web and the lower web and the rail element is U-shaped in a section perpendicular to its main axis of extension.

10. The vehicle seat according to claim 2, wherein
the rolling element and the sliding element are at least partially enclosed by the U-shaped first rail element and the rolling plane is formed by the first surface of the upper web or the lower web and the sliding plane is formed by the second surface of the central web.

11. The vehicle seat according to claim 1, wherein
the vehicle seat base has a third rail element which is arranged parallel to the first rail element and/or has a fourth rail element which is arranged in its main axis of extension parallel to the main axis of extension of the second rail element, the first scissors arm being connected to the third rail element by means of a second floating bearing wherein the second floating bearing has a second rolling element with the axle and a second sliding element and the second rolling element and the second sliding element are arranged one behind the other in the rolling axis direction, wherein the second rolling element has at least one contact point with a second rolling plane of the third rail element and the second sliding element has at least one contact point with a second sliding plane of the third rail element or of the fourth rail element, wherein
the second rolling plane and the second sliding plane are aligned at a second angle β from a range 0<β<90° to one another.

12. The vehicle seat according to claim 11, wherein
the rolling plane is equal to the second rolling plane and the angle α is equal to the second angle β.

13. A vehicle seat comprising a seat part and a vehicle seat base with an adjustment device for displacing the vehicle seat relative to the body in at least one of the longitudinal direction (X) the width direction (Y) or the height direction (Z) and a frame part for supporting the seat part or for fastening it to a vehicle body, the frame part having at least one first rail element, the adjustment device being connected to the first rail element by means of at least one floating bearing wherein the floating bearing has a rolling element with a rolling axis and a sliding element and the rolling element and the sliding element are arranged one behind the other in the rolling axis direction, wherein the rolling element has at least one contact point with a rolling plane of the first rail element and the sliding element has at least one contact point with a sliding plane of the first rail element or of a second rail element of the frame part, wherein
the rolling plane and the sliding plane are aligned at an angle (α) from a range 0<α<90° to each other.
